(19) United States
(12) Patent Application Publication
(10) Pub. No.: US 2005/0274772 A1
(43) Pub. Date: Dec. 15, 2005

(54) Treating an area to increase affinity for a fluid

(76) Inventors: Curtis L. Nelson, Corvallis, OR (US); Cary G. Addington, Albany, OR (US); Jimmy Perez, Corvallis, OR (US); John M. Koegler III, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/867,046

(22) Filed: Jun. 14, 2004

(51) Int. Cl. B23K 1/00

(52) U.S. Cl. 228/101

(57) ABSTRACT

Methods to treat an area on a surface to increase affinity for a fluid having a solution of particles including a conductive material.

### BACKGROUND

It can be difficult to achieve a fine control of the distribution of a fluid on a surface, e.g. in a fine surface pattern of thin lines.

Formation of conductive traces on a substrate surface can be done using photolithographic techniques to etch away all of a conductor layer on the substrate except in the conductor trace pattern. This is a relatively expensive procedure. Photolithographic techniques also tend to be high temperature, which may be a disadvantage for a plastic substrate application, or for an application in which multiple layers are being built up, and lower layers may experience electromigration when heated.

### BRIEF DESCRIPTION OF THE DRAWINGS

Features and advantages of the disclosure will readily be appreciated by persons skilled in the art from the following detailed description when read in conjunction with the drawing wherein:

FIG. 1A is a diagrammatic enlarged not-to-scale side view illustrating an exemplary jetted droplet about to contact an embodiment of a substrate. FIG. 1B shows the substrate after the exemplary droplet has come into contact with the surface. FIG. 1C diagrammatically depicts an embodiment of a substrate on which an embodiment of a conductor trace pattern is formed.

FIG. 2 schematically illustrates an exemplary embodiment of a system for surface treating the surface of a substrate.

FIG. 3A diagrammatically depicts an exemplary embodiment of a mask for laser treating an embodiment of a trace pattern using the system of FIG. 2. FIG. 3B schematically illustrates an exemplary embodiment of a mask for laser treating a surface region bordering the trace pattern to be created.

FIGS. 4A-4B illustrate an exemplary system for scanning a laser beam scanned across the exemplary masks in order to pattern an area on which exemplary particles, such as nanoparticles, are to be deposited on the substrate.

FIGS. 5A-5C are simplified block diagrams of exemplary laser surface treatment systems.

FIG. 6 is a schematic block diagram of an exemplary embodiment of a system for depositing the nanoparticles on the substrate surface.

FIG. 7 is a flow diagram illustrating an exemplary technique for applying a nanoparticle solution to the substrate.

FIG. 8 is a schematic block diagram of an exemplary embodiment of a system for laser sintering the nanoparticles.

FIG. 9 is a general flow diagram of an embodiment of a process for forming conductive traces on a substrate.

### DETAILED DESCRIPTION

In the following detailed description and in the several figures of the drawing, like elements are identified with like reference numerals.

In an exemplary embodiment, it is desired to distribute a solution of particles on a surface of a substrate in a defined pattern which establishes a conductor trace pattern. The particles can be small particles, and in one exemplary embodiment can be nanoparticles. Nanoparticles may be organic or inorganic particles that are typically smaller than 200 nanometers. These particles may also have an organic shell with a ligand structure to reduce agglomeration. The particles are then suspended in an aqueous or solvent based solution. In other embodiments, the particles may be larger that nanoparticles.

Laser surface treatment can be used to modify a surface to change the surface energy of the substrate so that a solution, e.g. a solution of particles, more evenly distributes on the surface. One laser surface treatment is to decrease the surface energy. Alternatively, a different laser surface treatment can modify a surface to increase the surface energy. A combination of the two treatments can be used to selectively pattern a surface to attract particles in the solution to areas on which conductive traces are to be placed.

The two treatments may differ in fluence, shot count, gas environment. An example of a treatment to increase the attraction for silver nanoparticles in alpha-terpineol solution air-brushed onto a Kapton (TM) substrate is a laser treatment using a 248 nm laser, 200 mJ/cm2 fluence, 100 shots, resulting in a continuous, substantially even coverage when air-dried. The laser treatment increases the surface roughness from RMS roughness of 59 nm to 215 nm, and the contact angle of a test fluid, distilled water, drops from 98 degrees to 65 degrees immediately after deposition and then to 35 degrees after the fluid has been in contact with the surface for about 10 minutes. An exemplary treatment that decreases the attraction is a 248 nm laser on a substrate of PEN (polyethylene naphthalate) with a fluence of 250 mJ/cm2 and 7 shots, resulting in a contact angle increase for a test fluid, distilled water, from 69 degrees to 145 degrees. Other types of surface modifications suitable for the purpose include a film, such as a fluorinated polymer, or a plasma treatment. For example, by applying a 0.1-10 μm thick polymer coating, the surface energy of a material can be changed to either increase or decrease the wettability. By using a plasma treatment, surface roughness and/or chemistry changes can be caused.

After this surface modification, when a solution, e.g. a solution of nanoparticles, is dispensed, e.g. sprayed, jetted or spincoated, onto the surface, the nanoparticles will arrange themselves into a predetermined pattern that is then ready for the next step in processing. This next step may include laser-sintering the nanoparticles together to form conductive traces, or other treatment processes, such as, by way of example only, thermal annealing in an oven and infrared treatment.

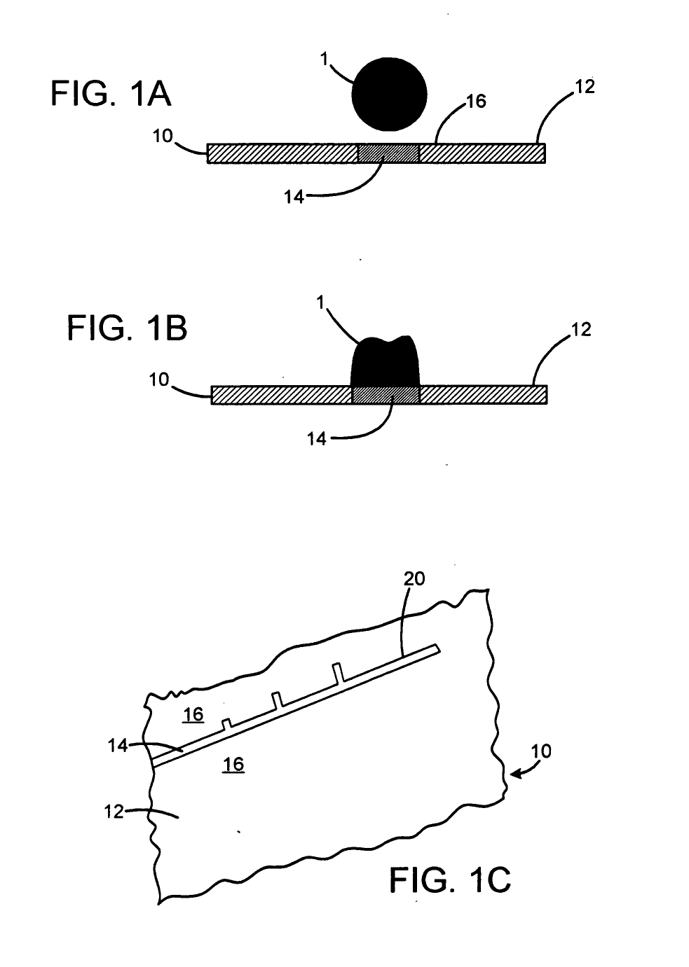

FIG. 1A is a diagrammatic enlarged not-to-scale side view illustrating a jetted droplet 1 about to contact a substrate 10 whose top surface 12 has been laser-patterned to create a surface trace region 14 which has a wetting surface characteristic and an adjacent surface region 16 which has a non-wetting surface characteristic. FIG. 1B shows the substrate after the droplet 1 has come into contact with the surface and has moved to the wetting region. In this example, the droplet has a diameter size which is larger that the width of the trace region 14. Since the resolution of light, i.e. the laser beam size, can be used to create finer features than jetted droplet sizes, this allows trace widths to be controlled without firing correspondingly finer droplet sizes or volumes. Moreover, drop directionality tolerances can be loosened, since the droplets will move to the regions of the wetting surface, and away from the regions of the non-wetting surface.

Laser surface treatment can increase nanoparticle coverage on the surface. For example, nanoparticle coverage on a Kapton (TM) surface has been increased when the surface is subjected to a laser surface treatment. A substantially even coverage of nanoparticles may be obtained, while reducing clumping together or the formation of striated patterns. This may be useful for making continuous conductors or dielectrics with proper insulating properties. Other suitable substrate materials include polymers and glass, such as Corning 1737.

Depositing nanoparticles on a surface and laser-sintering them into conductive traces can be employed in the fabrication of electronic devices. In the laser-sintering, heat may flow laterally from the focused laser beam, melting a swath of nanoparticles that is wider than the beam. This can make it more difficult to create relatively narrow trace widths. By treating the surface of the substrate before application of the nanoparticles, the nanoparticles are substantially confined to an area that is the width of the trace that is desired. For example, in one embodiment, if a 10 micron wide trace is desired, a mask is used to expose a 10 micron wide area to a laser-surface treatment that increases the affinity of the treated surface to the nanoparticle solution. The surface on either side of the affinity-increasing treated surface can then be optionally exposed to a laser treatment that results in a surface that repels the nanoparticle solution. The result is a 10 micron wide line of nanoparticles that is ready for a subsequent treatment, such as laser sintering. Thus, in this exemplary embodiment, there are two laser treatments steps, the surface treatment to affect the nanoparticle distribution, and the second a subsequent laser-sintering treatment to melt the nanoparticles into a conductive trace. The surface treatment can in turn be two treatments, i.e. the first treatment on the trace area to increase surface affinity to the nanoparticles, and the second treatment on surface regions on either side of the first treatment area to decrease surface affinity to repel the nanoparticles.

In sintering a nanoparticle distribution, porosity of the sintered trace may decrease conductivity. In some embodiments, the surface treatment can result in increased density of the nanoparticles in the trace area. This increase in density can correspond to an increase in conductivity, so that the conductivity of the sintered trace is closer to the conductivity of the bulk conductor material.

FIG. 1C is an isometric diagrammatic not-to-scale view of an exemplary substrate 10 having a surface 12, on which a simple trace pattern 20 is indicated, which is intended to occupy a trace region 14 of the surface 12. In an exemplary embodiment, the surface trace region 14 is treated to modify its wettability characteristics. The wetting characteristics of a surface may be “wetting” or “non-wetting” and may also vary along a range within and between each category. “Wetting” means that the surface energy of the surface is greater than that of the fluid that is in contact with the surface. “Non-wetting” means that the surface energy of the surface is less than that of the fluid that is in contact with the surface. Fluid tends to bead on non-wetting surfaces and spread over wetting surfaces. In an exemplary embodiment, the surface treatment is a laser treatment. The surface regions 16 adjacent the surface trace region 14 can be treated to achieve a different surface characteristic. In an exemplary embodiment, the trace region 14 is treated to increase its wettability, and the adjacent surface regions treated to decrease its wettability. Increasing the wettability increases the surface affinity for nanoparticles. Decreasing the wettability decreases the surface affinity for nanoparticies.

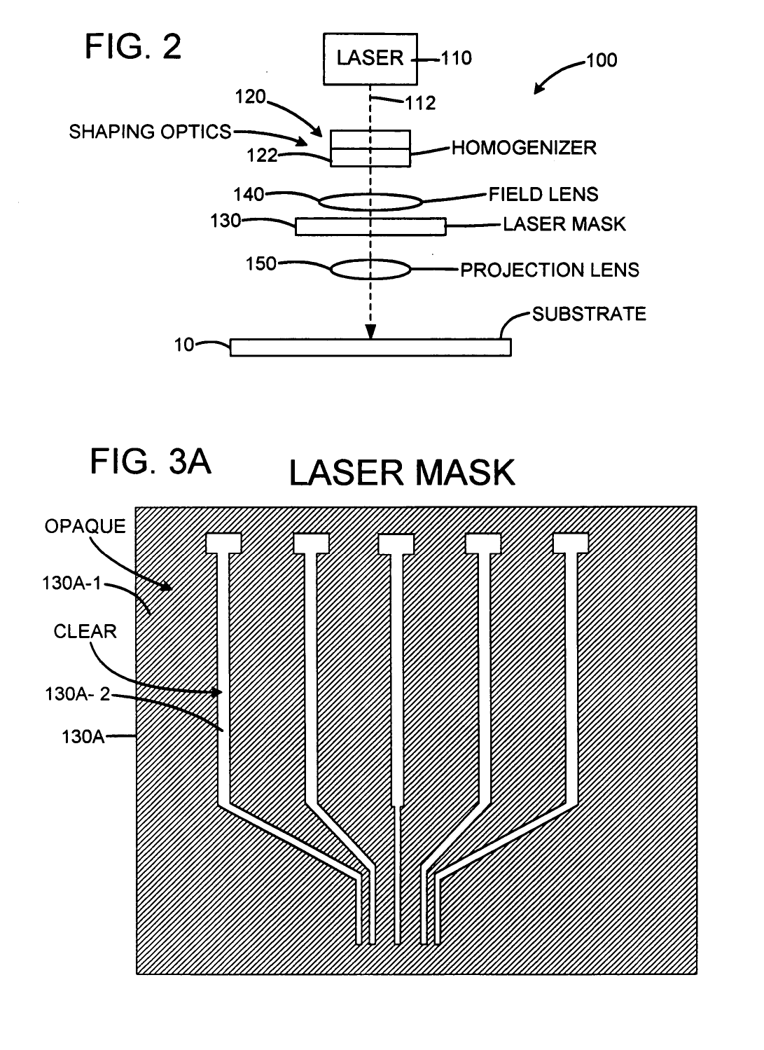

FIG. 2 schematically illustrates an exemplary embodiment of a laser ablation system 100 for surface treating the surface of a substrate by laser ablation. A laser 110 generates a laser beam 112; in one exemplary embodiment, the laser is a pulsed excimer laser operating at a wavelength of 248 nm. The beam 112 is passed through shaping optics 120 which includes a homogenizer 122. In this exemplary system, the shaping optics 120 includes a set of lenses that collimate the laser light and expand the size and shape of the laser beam to what is needed for the particular application. The homogenizer 122 includes optical elements that make the intensity profile of the laser beam uniform. The beam is passed through the field lens 140, then through the laser mask 130. The image is then reduced in size by a projection lens 150 which also focuses the mask pattern onto the substrate 10. The beam width before the projection lens may be wider than the trace to be formed. An exemplary projection lens typically has a 1-10× reduction in magnification, and focuses the beam to the desired trace width.

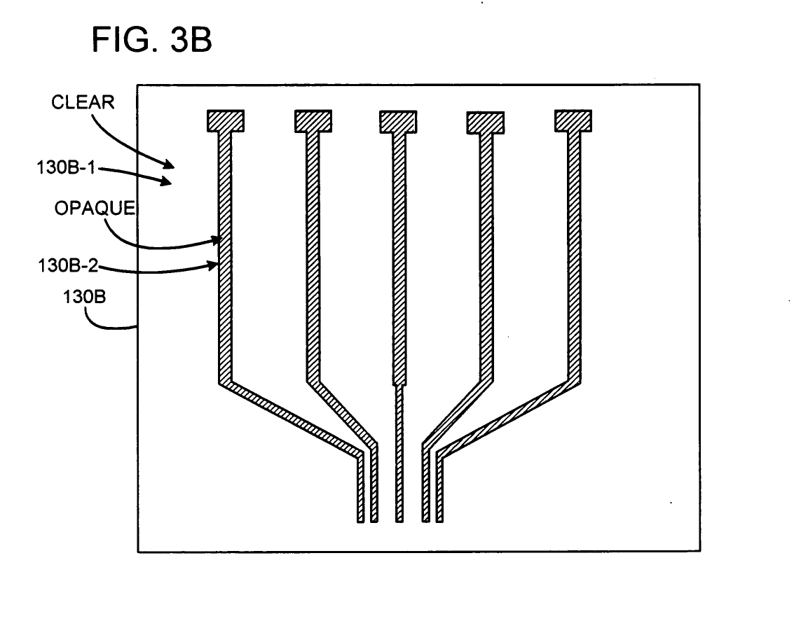

The laser mask 130 is designed to pattern certain areas on the substrate 10. One mask is used to pattern areas with the laser treatment that is designed to attract nanoparticles. FIG. 3A illustrates a simple mask 130A. The mask has opaque regions 130A-1 which substantially prevent the laser beam from passing through the mask and onto the substrate surface. Optically clear regions 130A-2 of the mask allow the laser beam to pass through onto the substrate surface. A second mask 130B is used for the second treatment which is designed to repel nanoparticles. Optically clear regions 130B-1 allow the laser beam to pass through onto the substrate surface, and opaque regions 130B-2 substantially prevents the beam from passing through the mask and onto the substrate surface. This mask allows the beam to pass through to surface regions that border the trace regions, while masking the trace regions, as well as portions of the substrate surface away from the border regions.

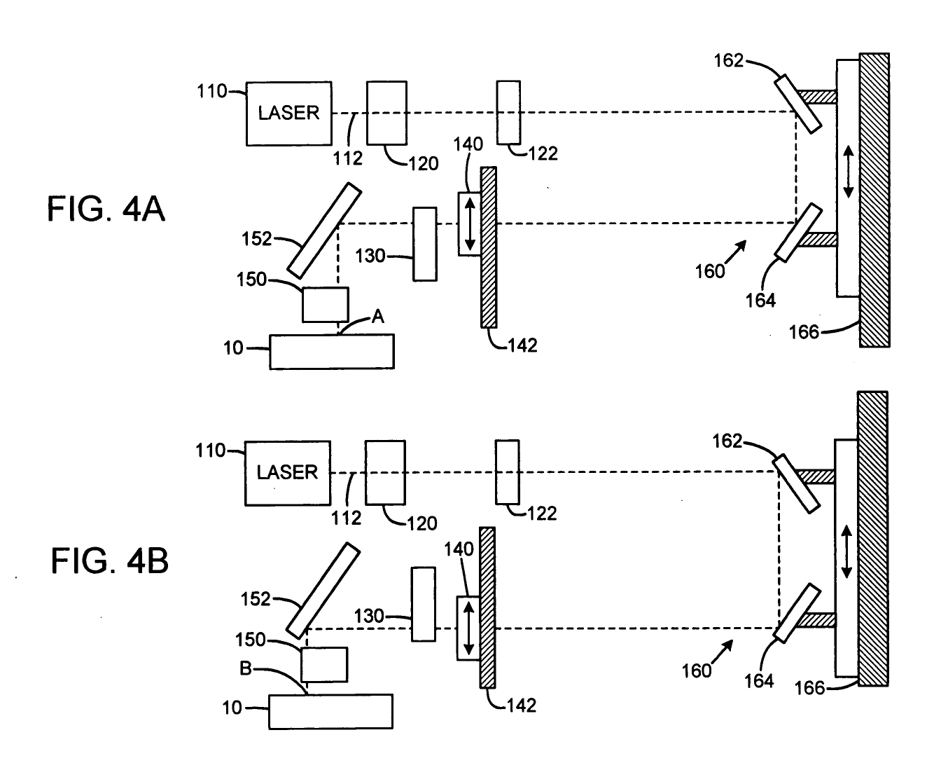

The laser beam is scanned across the masks in order to pattern the area on which nanoparticles are to be deposited on the substrate. FIGS. 4A-4B illustrate an exemplary system. In this exemplary embodiment, a set of mirrors 162, 164 is mounted on a linear stage 166, and the stage can be moved to illuminate different portions of the mask 130. In this embodiment, the field lens 140 is also mounted on a linear stage 142 so that its optical center can stay inline with the moving laser beam via the mirror set. Other arrangements can alternatively be employed. FIG. 4A shows the mirror scan stage 166, 142 at one location, directing the beam onto the substrate at point A. FIG. 4B shows the mirror scan stages in different positions, directing the beam onto the substrate at point B. In other embodiment, the mirrors 162,164 may be omitted.

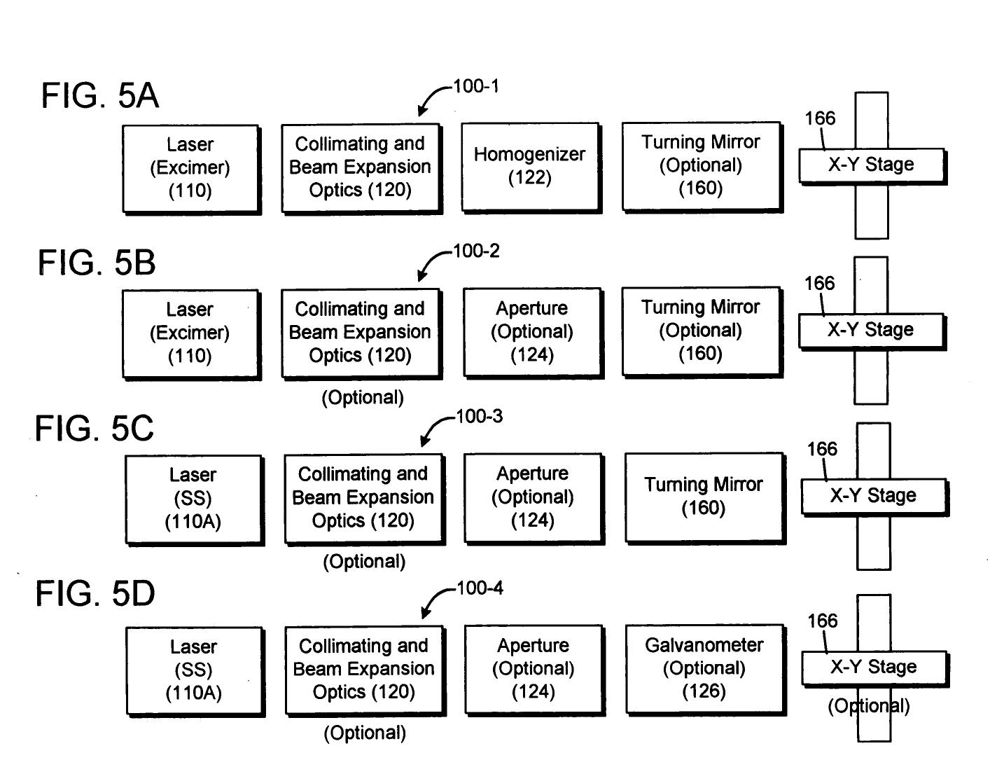

Excimer lasers of a type selected from the following non-limiting alternatives can be employed in the laser ablation system: F₂, ArF, KrCl, KrF, and XeCl. An exemplary laser ablation system is described, for example, in U.S. Pat. No. 5,305,015. In an exemplary embodiment, the mask may be highly reflective at the laser wavelength, such as a multi-layer dielectric or a metal such as aluminum or chrome. Exemplary pulse energies and durations include 20-750 mJ/cm2, 1-1000 pulses, 0.3-250 ns. Simplified block diagrams of exemplary laser surface treatment systems are shown in FIGS. 5A-5C. FIGS. 5A-5B show excimer laser systems 100-1 and 100-2. System 100-1 employs an excimer laser 110, and includes collimating and beam expansion optics 120 and homogenizer 122. An optional turning mirror system 160 to change the beam's optical path. An X-Y stage 166 is used to position the turning mirror or the substrate to scan the beam.

System 100-2 also includes an excimer laser 110, optional collimating and beam expansion optics 120, optional turning mirror 160 and an X-Y stage 106. This alternate embodiment employs an aperture 124 in an opaque plate. For certain types of materials, where intensity uniformity may be less, the raw Excimer beam is good enough to perform the surface modification without beam modification optics. A simple aperture will clip the edges of the beam to obtain edge definition.

Solid state lasers such as, but not limited to Nd:YAG or Nd:YVO4, can be used for the surface treatment. These lasers have a smaller beam diameter (1-3 mm beam diameter) and thus cover a smaller area than that of an Excimer laser. At times, these solid state lasers may provide the capability of being able to direct write a treated pattern onto the substrate by using its point source beam and using a galvanometer or X-Y stage to draw the pattern. Also for harder materials, the solid state lasers can produce energy densities greater than 200 J/cm². Solid state lasers can be focused to a smaller spot and the better beam quality allows all the laser beam's energy to be focused. An exemplary system 100-3 is shown in the simplified block diagram of FIGS. 5C-5D. In FIG. 5C, this exemplary system employs the solid state laser 110A, with optional collimating and beam expansion optics 120, optional aperture 124 and turning mirror 160, as well as an X-Y stage 166. In FIG. 5D, this exemplary system employs the solid state laser 110A, with optional collimating and beam expansion optics 120 and optional aperture 124, but with an optional galvanometer 126 in place of a static turning mirror as well as an optional X-Y stage 166. A galvanometer system has a set of x-y mirrors, each placed on a galvanometer. These mirrors turn the beam 90 degrees and will induce an angular displacement from the optical axis. An F-theta lens focuses the beam. The purpose for using this type of lens is that it changes the beam path from an angular deviation to a true translation. By doing this, the focal plane within the optical field of view is flat instead of spherical.

In an exemplary embodiment, the fluence of the laser may be adjusted to cause ablation of the substrate surface. Fluence, as used herein, refers to the number of photons per unit area, per unit time. Ablation, as used herein, refers to the removal of material through the interaction of the laser with the surface. Through this interaction, the surface is activated such that the surface bonds are broken and surface material is displaced away from the surface, thereby changing the surface texture.

The fluence of the laser typically is adjusted based on the characteristics of the substrate material to be ablated as well as the desired surface texture. In one embodiment, the laser light is directed to areas of the substrate that are intended to receive the laser surface treatment, while areas that are not to receive the surface treatment may be masked off, or otherwise not exposed to laser light, so that these areas remain unaltered.

The actual texture of the surface obtained via laser ablation may depend on the number of pulses, pulse width, pulse intensity, frequency, wavelength and energy density, and/or the type of surface material. In one embodiment, the fluence typically should exceed a predetermined threshold before ablation of the surface occurs. If the fluence is below this threshold, then there will be little or no ablation and no removal of the surface material. The ablation threshold is dependent on the characteristics of the material being ablated and the light source. In laser ablation, short pulses of intense laser light are absorbed in a thin surface layer of material within about 1 micrometer or less of the surface. In an exemplary embodiment, the laser pulse energies are on the order of 50-700 mJ, with pulse durations on the order of 10-100 ns.

The surface texture can be defined and quantified by a “contact angle” value, which is the angle of intersection between the surface and a fluid drop, i.e. the angle defined by the surface and a tangent to the drop where it contacts the surface. A high contact angle, for example, corresponds with a non-wetting surface, while a low contact angle corresponds with a wetting surface. In one embodiment, a contact angle of 10 degrees or less corresponds with a “highly wettable” surface that causes a fluid to spread extensively, or “wets out” over the surface. A contact angle between 10 and 90 degrees corresponds with a wetting surface. A contact angle of 90 degrees or greater corresponds with a non-wetting surface.

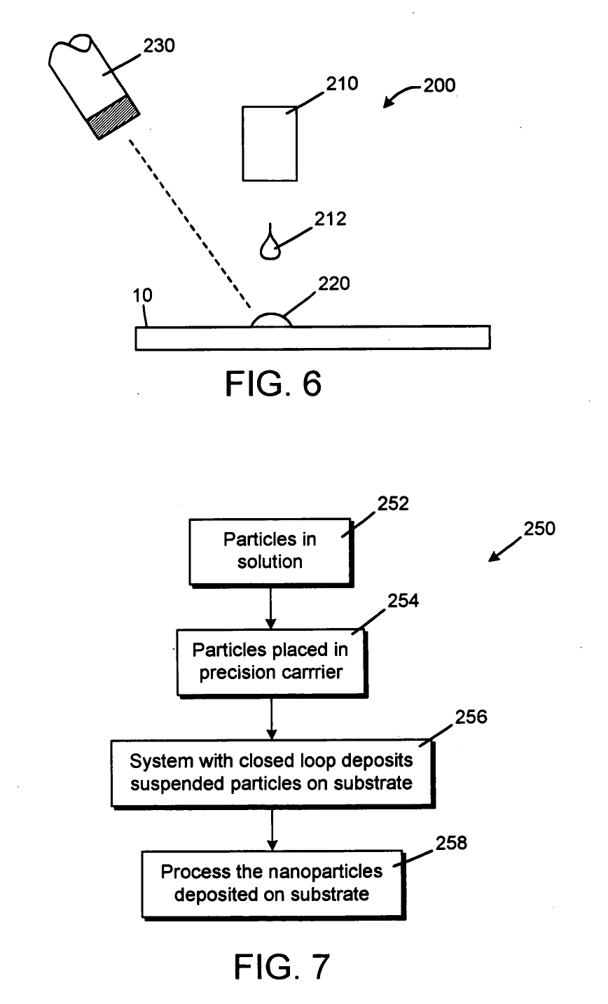

After the substrate surface has been treated as described above, the nanoparticles are deposited on the trace region. In an exemplary embodiment, the nanoparticles are in a fluid, and the fluid is jetted onto the surface using a thermal fluid drop generator, e.g. of a type used in inkjet printing. FIG. 6 is a schematic block diagram of an exemplary embodiment of a system 200 for depositing the nanoparticles on the surface of substrate 10. FIG. 6 diagrammatically depicts an exemplary quantity of fluid 220 carrying the nanoparticles after being jetted onto the substrate surface. As a result of the surface treatment, the nanoparticles will arrange themselves into a predetermined pattern defined by the surface treatment. The system of FIG. 6 employs a fluid jetting device 210 which is controlled to emit drops 212 of fluid containing the nanoparticles. This device may include a thermal inkjet printhead, a spray head, a needle dispenser or a pipette. The system 200 in an exemplary embodiment includes a locator system for the substrate, i.e. an X, Y, Z locator. The device 210 may include a scanning carriage for moving the print carriage relative to the surface. A locating/fluid drop landing system 230, e.g. a camera system, can be employed to optically sense the location of the jetted drops onto the substrate. The sensed information can be used to control the jetting device and an X-Y positioning system which provides relative positioning movement between the substrate and the jetting device. This can be a closed loop feedback system to accurately control the jetting device and the location of the jetted drops on the substrate.

Exemplary nanoparticle materials suitable for the purpose include gold, silver, copper, nickel and palladium, as well as alloys of these materials. Suitable nanoparticles are commercially available, but can also be fabricated by a number of methods, including physical vapor synthesis. Nanoparticles may include organic or inorganic particles that are typically smaller than 200 nanometers. These particles also have an organic shell with a legend structure to reduce. agglomeration. The particles are then suspended in an aqueous or organic media. Examples of organic media suitable for the purpose include Toluene, alcohols (including ethanol and iso-propanol)and n-methyl pyrrolidone (NMP). Other types of nanoparticles and fluids can alternatively be used.

FIG. 7 is a flow diagram illustrating an exemplary technique 250 for applying the nanoparticle solution to the substrate. At 252, the nanoparticles are prepared in solution. The nanoparticle solution is then placed in a precision carrier at 254, e.g. a thermal inkjet pen, or a needle dispenser or an aerosol dispenser. At 256, the carrier is actuated to dispense the nanoparticle solution on the substrate, using a closed loop feedback system to control the precision carrier. After the nanoparticles have been deposited on the substrate, the substrate and the nanoparticles are processed at 258 to form the conductive traces. This processing can include, without limitation, laser sintering the nanoparticles together to form the conductive traces, thermal annealing in an oven, and/or infrared treatment.

Laser sintering is the use of laser light to thermally decompose the particles into a continuous film. This can be done using laser energy in a continuous wave (cw) or pulsed format. Typically a cw format is preferred. The wavelength of the laser is selected to match the absorption of the nanoparticles and/or its organic shell. In the case of high temperature substrates, the substrate may be locally heated by the laser beam to sinter the nanoparticles.

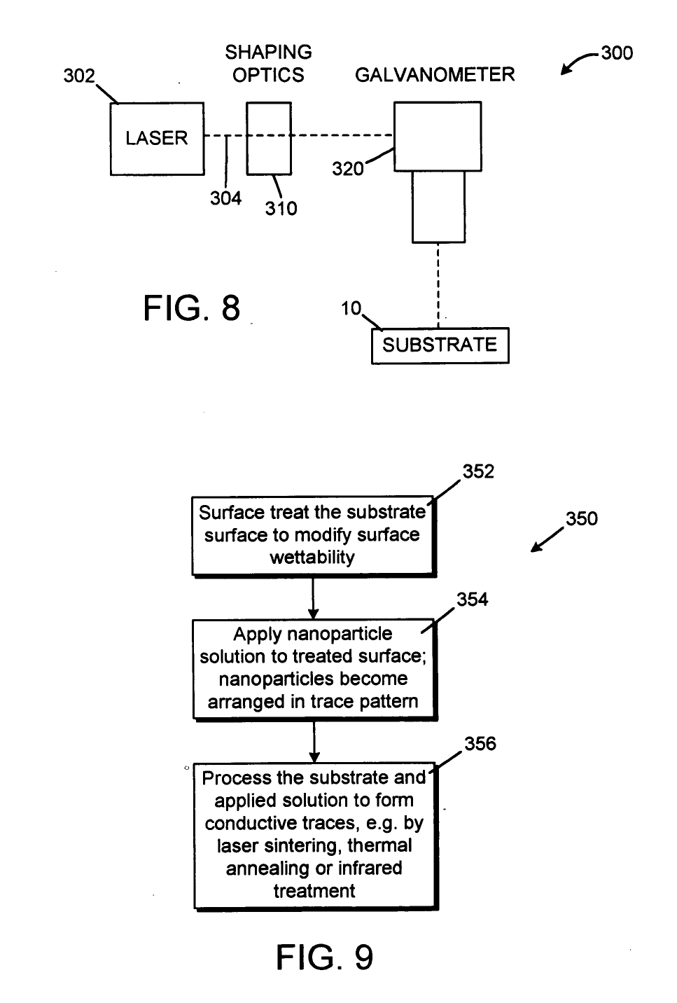

FIG. 8 is a schematic block diagram of an exemplary embodiment of a system for laser sintering the nanoparticles. A laser 302 generates the laser beam 304, which is passed through shaping optics 310 and to a galvanometer 320. The galvanometer directs the laser beam onto the nanoparticle solution pattern to sinter the nanoparticles.

Thermal annealing can be done in an oven. The process is to heat up the substrate and nanoparticle solution until the melt temperature of the nanoparticles is exceeded. The component is then baked for a specific time.

Infrared heating is another technique for transforming the nanoparticle solution into a solid trace. This can be done, e.g., by industrial ovens utilizing infrared heaters or tubular quartz heaters, which allow top coats and powders to absorb the energy directly, curing with the substrate interface, without heating the entire thickness of the substrate to peak substrate temperature. These systems can provide a precise temperature control by incorporating zones and closed loop feedback for product quality. Air can be introduced to aid in drying water and solvent based coatings, primers and pretreatments.

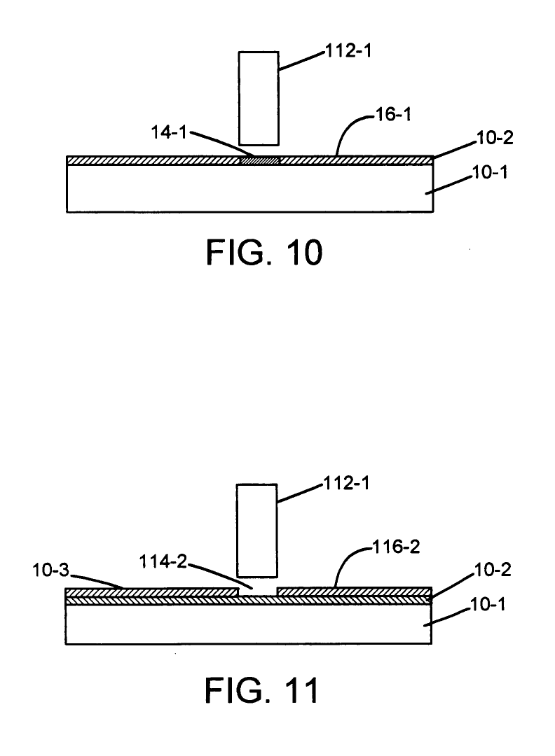

An exemplary embodiment of a process 350 for forming conductive traces on a substrate is depicted in the general flow diagram of FIG. 9. At step 352, the substrate surface is treated to modify the surface wettability. This can include laser ablating the trace region so as to increase the surface wettability and thus the surface affinity for a fluid containing nanoparticles. Optionally, the surface region adjacent the trace region can be treated so as to decrease its wettability. At step 354, a nanoparticle fluid solution is applied to the surface, e.g. by jetting or spraying. The nanoparticles become arranged in a predetermined trace pattern. At 356, the substrate is processed such that the nanoparticles become a conductive trace pattern.

The substrate with the conductive traces can be utilized in electronic devices. For example, the substrate can be used as a wiring board or substrate to conduct electrical signals along the trace pattern. The substrate can be populated with passive and active electronic devices.

In another embodiment, a flexible substrate material, e.g. PET or PEN, (polyethylene terephthalate and polyethylene naphthalate) has a polymer layer attached to it or coated on a surface of the substrate. The polymer layer is partially linked, and is designed so that the partially linked surface area is non-wetting. Non-wetting polymers can be formed with hexylacrylates and dodexylacrylates. Wetting polymers can be created with polyethylene glycols, particularly graft polymers or carboxylates. Suitable layer thickness range from about 0.5 um to 50 um, in an exemplary embodiment. A laser is then used to finish the polymerization of certain areas of the polymer layer to define wetting surface areas. FIG. 10 illustrates this substrate structure and laser treatment. A flexible substrate 10-1 has a polymer layer 10-2 formed on a substrate surface. The polymer layer 10-2 is partially cross-linked so that its exposed surface is non-wetting. A laser generates a beam or laser light column 112-1 onto a surface region 14-1 which is to define a trace region, to complete the polymerization of this region 14-1, creating a wetting region. Two exemplary types of cures can be used with polymers. Heat curing is used with epoxylamines, and photoinhibator curing, i.e. UV light, is used with acylates. For heat curing, laser examples suitable for the purpose are CO2, GA/AS, and semiconductor. The CO2 laser emits IR light in the 1-3 um wavelengths. GA/AS lasers emit light in the near IR spectrum, 780-850 nm wavelengths, and semiconductor lasers emit in the 650 nm wavelengths or visible red. UV sources can be had from LED's or from Xenon lamps. In most cases, 100 mW of power or more is used.

The polymer layer 10-2 also acts as a thermal layer for the flexible substrate 10-1, such that the heat generated by the laser light in the polymer layer does not affect the dimensional stability of the substrate. In some embodiment, a polymer layer may be coated on both sides of the substrate to reduce deformation caused by film layer stresses. Other methods include liquid spin coating and pressed-on films.

Another technique for creating non-wetting and wetting regions is to place a second very thin layer 10-3 of a non-wetting material, such as PTFE (poly tetra fluro ethylene), on top of the first polymer layer 10-2, as illustrated in FIG. 11. In this embodiment, the first layer 10-2 is fully polymerized, and has a wetting surface characteristic. The second polymer layer 10-3 is used as a “mask” layer. The laser wavelength is tuned to the second layer 10-3 and the heat generated inside the second layer causes it to burn away as illustrated in FIG. 11. “Tuning the layer” in this context means that the atomic structure of the polymer would absorb or be excited by the certain wavelength given off by a particular laser. Thus the light would not be substantially transmitted or substantially reflected by the polymer layer. If the layer absorbed enough energy, it will burn or oxidize rapidly. In this exemplary embodiment, the first layer's function is to act as a thermal layer for the substrate, and to provide a wetting surface which is exposed when the second layer is selectively removed by exposure to the laser beam.

Referring to the embodiments of FIGS. 10-11, once the wetting and non-wetting regions have been created, the device solution(s) can be dispensed onto the flexible substrate, e.g. using dispensing techniques described above. The solution is dispensed over the wetting regions 14-1 and 114-2. Once the solution is dispensed, the solution can be laser sintered, thermally annealed, or otherwise processed to create the desired conductor trace or device. For example, low temperature processing can be used to finish the trace, e.g., oven-bake or uv/visible/ir lamp, rf or microwave processing. The second layer 10-3 in the embodiment of FIG. 11 can be removed for further device processing if needed.

Although the foregoing has been a description and illustration of specific embodiments, various modifications and changes thereto can be made by persons skilled in the art without departing from the scope and spirit of the claimed subject matter as defined by the following claims.

1. A method, comprising:
treating an area on a surface to increase affinity for a fluid having a solution of particles comprising a conductive material.

2. The method of claim 1, further comprising:
dispensing the fluid onto the surface.

3. The method of claim 2, further comprising:
treating the solution of particles on the surface to form a solid conductive region.

4. The method of claim 3, wherein said treating the dispensed solution of particles comprises one of laser sintering the particles, infrared heating and thermal annealing.

5. The method of claim 2, further comprising:
illuminating the dispensed solution with laser energy to laser-sinter the particles together.

6. The method of claim 1, wherein said treating an area comprises laser ablating the area.

7. The method of claim 2, further comprising:
before dispensing the fluid onto the surface, treating an area of the surface adjacent the treated area to provide a surface area which repels the fluid.

8. The method of claim 6, wherein said treated area which repels the fluid is non-wetting.

9. The method of claim 7, wherein said treating said area of the surface to provide a surface area which repels the fluid comprises laser ablating said area of the surface.

10. The method of claim 1, wherein said treated area of the surface is wetting.

11. The method of claim 1, wherein the surface is formed on a polyimide substrate.

12. The method of claim 1, wherein said particles are nanoparticles of a material selected from the group consisting of gold, silver, copper, nickel and palladium, and alloys of one or more of said materials.

13. The method of claim 1, wherein said small particles are nanoparticles which are suspended in an aqueous or organic media.

14. The method of claim 1, wherein said surface is a surface of a flexible substrate.

15. The method of claim 2, wherein said dispensing the fluid comprises:
ejecting drops of the fluid from a fluid drop generator.

16. The method of claim 1, wherein the surface is a surface of a partially linked polymer layer, and said treating said area of the surface comprises further polymerizing said area of the surface of the polymer layer.

17. The method of claim 1, wherein the surface is a surface of a non-wetting polymer material layer formed on a wetting polymer layer formed on a substrate, and wherein said treating said surface region comprises removing the non-wetting layer in said surface region to expose said wetting polymer layer.

18. The method of claim 17, wherein said substrate is a flexible substrate.

19. A method for making a trace, comprising:
treating a strip on a substrate to increase affinity for a particulate solution comprising particles including a conductive material;
dispensing the particulate solution onto the strip, the treating tending to confine the particulate solution to the strip; and
processing the particulate solution dispensed on the strip to form the particles into the trace.

20. The method of claim 19, wherein the substrate is a dielectric substrate.

21. The method of claim 19, wherein said processing the particulate solution comprises processing the particulate solution to form a solid conductive trace.

22. The method of claim 19, wherein said processing the dispensed particulate solution comprises:
directing laser energy onto the dispensed particulate solution to laser-sinter the particles.

23. The method of claim 19, further comprising the step of:
before dispensing the particulate solution onto the substrate, treating an area of the substrate adjacent the strip to provide a surface area which repels the particulate solution.

24. The method of claim 19, wherein the substrate is a polyimide substrate.

25. The method of claim 19, wherein the substrate is a flexible substrate.

26. The method of claim 10, wherein said particles are nanoparticles of a material selected from the group consisting of gold, silver, copper, nickel and palladium, and alloys of one or more of said materials.

27. The method of claim 19, wherein said particles are nanoparticles which are suspended in an aqueous or organic media.

28. The method of claim 19, wherein said processing the dispensed particulate solution comprises infrared heating or thermal annealing.

29. The method of claim 19, wherein said dispensing the particulate solution comprises:
jetting drops of the particulate solution from a thermal drop generator.

30. The method of claim 19, wherein said trace has a width dimension of 10 microns or less.

31. The method of claim 19, wherein the surface is a surface of a partially linked polymer layer formed on the substrate, and said treating said strip comprises further polymerizing said strip of the polymer layer.

32. The method of claim 19, wherein the strip is a surface of a non-wetting polymer material layer formed on a wetting polymer layer, formed on the substrate, and wherein said treating said strip comprises removing the non-wetting layer in said strip to expose said wetting polymer layer.

33. An electrical circuit board fabricated according to the method of claim 19.

34. A method for controlling nanoparticle distribution on a surface, comprising:
treating a partial surface area on the surface to increase affinity for a liquid nanoparticle solution; and
dispensing the nanoparticle solution onto the treated area, the surface treating tending to confine the nanoparticle solution to the treated area.

35. The method of claim 34, further comprising:
treating the dispensed nanoparticle solution to melt the nanoparticles to form a solid conductor trace.

36. The method of claim 34, wherein said treating the dispensed nanoparticle solution comprises one of laser sintering the nanoparticles, infrared heating and thermal annealing.

37. The method of claim 34, further comprising:
illuminating the dispensed nanoparticle solution with laser energy to laser-sinter the nanoparticles together.

38. The method of claim 34, further comprising:
before dispensing the nanoparticle solution onto the surface, treating an area of the surface adjacent the partial surface area to provide a surface area which repels the nanoparticle solution.

39. The method of claim 34, wherein the surface is formed on a polyimide substrate.

40. The method of claim 34, wherein the nanoparticle solution comprises of a material selected from the group consisting of gold, silver, copper, nickel and palladium, and alloys of one or more of said materials..

41. The method of claim 34, wherein said dispensing the nanoparticle solution comprises:
jetting drops of the nanoparticle solution from a thermal drop generator.

42. An electrical circuit board fabricated according to the method of claim 34.

43. A method for making a conductor trace on a dielectric substrate surface, comprising:
step for treating a surface area on the dielectric surface to increase affinity for a liquid particle solution comprising particles of a conductive material;
step for dispensing the particle solution onto the treated area; and
step for processing the particles into the conductor trace.

44. The method of claim 43, further comprising:
before dispensing the particle solution onto the substrate surface, step for treating an area of the surface adjacent the surface area having increased affinity for the liquid particle solution to provide a surface area which repels the nanoparticle solution.

45. The method of claim 43, wherein the dielectric substrate is a polyimide substrate.

46. The method of claim 43, wherein the particle solution comprises of a material selected from the group consisting of gold, silver, copper, nickel and palladium, and alloys of one or more of said materials.

47. The method of claim 43, wherein said step for dispensing the particle solution comprises:
ejecting drops of the particle solution from a fluid drop generator.

48. The method of claim 43, wherein said surface area has a width dimension of 10 microns or less.

49. The method of claim 43, wherein the treated surface area is in the form of a narrow strip.

50. The method of claim 43, wherein said step for processing the dispensed solution comprises directing laser energy onto the dispensed solution to laser-sinter the particles into the conductor trace.

51. The method of claim 43, wherein said step for dispensing the particle solution comprises:
jetting drops of the particle solution from a thermal drop generator.

52. An electrical circuit board fabricated according to the method of claim 43.

53. A system for fabricating a trace, comprising:
a system for treating a region on a substrate to increase affinity for a fluid solution including particles;
a system for dispensing the fluid solution onto the substrate; and
a system for applying heat to the dispensed fluid solution on the substrate to form the trace.

54. The system of claim 53, wherein the system for applying heat comprises a laser sintering system for illuminating the dispensed fluid with laser energy to laser sinter the particles.

55. The system of claim 53, wherein the system for treating a region on a substrate comprises a laser ablation system for ablating the surface with laser energy.

56. The system of claim 55, wherein the laser ablation system includes:
a mask for defining a trace pattern region, the mask having an opening pattern in an opaque region to allow laser energy to pass through the mask only through the opening pattern.

57. The system of claim 55, wherein the laser ablation system further comprises:
a laser for emitting a laser beam;
a beam scanning apparatus for scanning the laser beam in a controlled fashion over the substrate.

58. The system of claim 57, wherein the beam scanning apparatus includes a mirror system mounted on an X-Y table.

59. The system of claim 57, further comprising collimating and beam expansion optics.

60. The system of claim 57, further comprising an aperture though which the laser beam is passed.

61. The system of claim 57, wherein the beam scanning apparatus comprises a galvanometer.

62. The system of claim 53, wherein the surface treatment system is adapted to treat an adjacent surface region adjacent the surface region treated to increase affinity to decrease the affinity of the adjacent surface region for the fluid solution.

63. The system of claim 62 wherein the surface treatment system includes a laser ablation system including a laser for emitting a laser beam and a mask having a mask opening pattern which defines the adjacent surface region, the laser beam projected through the mask opening pattern onto the substrate during a surface treatment process.

64. The system of claim 53, wherein the dispensing system includes a fluid jetting device.

65. The system of claim 64, wherein the fluid jetting device comprises a fluid drop generator.

66. The system of claim 65, wherein the fluid drop generator is a thermal fluid jet generator.

67. A system for fabricating a trace on a substrate, comprising:
means for treating a region on the substrate to increase affinity for a fluid solution including particles;
means for dispensing the fluid solution onto the substrate; and
means for processing the dispensed fluid solution to form the trace.

68. The system of claim 67, wherein the means for processing comprises a laser sintering system for illuminating the dispensed fluid solution with laser energy to laser sinter the particles.

69. The system of claim 67, wherein the means for treating the substrate comprises a laser ablation system for ablating the substrate with laser energy.

70. The system of claim 69, wherein the laser ablation system includes:
means for masking for defining the treated region, the means for masking having defining an opening pattern in an opaque region to allow laser energy to pass through the mask only through the opening pattern.

71. The system of claim 69, wherein the laser ablation system further comprises:
a laser for emitting a laser beam;
a beam scanning apparatus for scanning the laser beam in a controlled fashion over the substrate surface.

72. The system of claim 71, wherein the beam scanning apparatus includes a mirror system mounted on an X-Y table.

73. The system of claim 67, wherein the means for treating the surface further comprises means for treating an adjacent surface region of the substrate adjacent the treated region to decrease the affinity of the adjacent surface region for the fluid solution.

74. The system of claim 73 wherein the means for treating the surface includes a laser ablation system including a laser for emitting a laser beam and a mask having a mask opening pattern which defines the adjacent surface region, the laser beam projected through the mask opening pattern onto the substrate surface during a surface treatment process.

75. A method, comprising:
modifying an area of the surface to increase affinity for a fluid, wherein the surface includes a partially linked polymer layer, said modifying said area comprising further polymerizing said area; and
dispensing the fluid onto the area.

76. The method of claim 75, wherein said polymer layer is coated on or attached to a flexible substrate material.

77. The method of claim 76, wherein said flexible substrate is one of polyethylene terephthalate and polyethylene naphthalate.

78. The method of claim 75, where the polymer layer is formed with at least one of hexylacrylates and dodexylacrylates.

79. The method of claim 75, wherein the polymer layer is formed with polyethylene glycols or carboxylates.

80. The method of claim 75, wherein the polymer layer has a layer thickness range from about 0.5 um to 50 um.

81. The method of claim 75, wherein said modifying an area comprises directing laser energy onto the area to complete said polymerizing.

82. The method of claim 75, wherein said modifying said area comprises completing said polymerizing of said area.

83. The method of claim 75, wherein said fluid is a solution of particles comprising an electrically conductive material.

84. A method, comprising:
modifying an area of a surface to increase affinity for a fluid, wherein the surface includes a non-wetting layer formed on a wetting layer formed on a substrate, and wherein modifying said area comprises removing the non-wetting layer in said area to expose said wetting layer; and
dispensing the fluid onto the area.

85. The method of claim 84, wherein said modifying said area of the surface comprises directing laser energy onto the area.

86. The method of claim 84, wherein said area is a partial surface area of a dielectric substrate.

87. The method of claim 84, wherein said fluid is a solution of particles comprising an electrically conductive material.

88. A method for controlling distribution of a fluid on a surface, comprising:
treating a partial surface area of the surface to increase affinity for the fluid; and
dispensing the fluid onto the surface, wherein the fluid is a solution of particles comprising an electrically conductive material.
